(19) United States
(12) Patent Application Publication
(10) Pub. No.: US 2014/0149024 A1
(43) Pub. Date: May 29, 2014

(54) METHOD AND SYSTEM FOR CONTROLLING START OF HYBRID ELECTRIC VEHICLE

(71) Applicants: Kia Motors Corporation, Seoul (KR); Hyundai Motor Company, Seoul (KR)

(72) Inventor: Sang Joon KIM, Seoul (KR)

(73) Assignees: Kia Motors Corporation, Seoul (KR); Hyundai Motor Company, Seoul (KR)

(21) Appl. No.: 14/058,058

(22) Filed: Oct. 18, 2013

(30) Foreign Application Priority Data
Nov. 23, 2012 (KR) 10-2012-0133819

(51) Int. Cl. F02N 11/08

(52) U.S. Cl. CPC F02N 11/0814
USPC 701/113

(57) ABSTRACT

Disclosed are a method and a system for controlling a start of a hybrid electric vehicle including a belt connecting an engine and an integrated starter-generator. The method for controlling a start of a hybrid electric vehicle including a belt connecting an engine and an integrated starter-generator according to an exemplary embodiment of the present invention includes: measuring characteristic values of the belt and storing the characteristic values in a memory; measuring a slip torque change rate of the integrated starter-generator causing belt slip according to the measured characteristic values of the belt and storing the slip torque change rate in the memory; determining whether there is a start demand of the engine; sensing a coolant temperature of the engine when there is the start demand of the engine; matching the sensed coolant temperature to the slip torque change rate; and feedback controlling the integrated starter-generator so that the torque change rate of the integrated starter-generator may be limited within the slip torque change rate when the engine is started.

### CROSS-REFERENCE TO RELATED APPLICATION

This application claims priority to and the benefit of Korean Patent Application No. 10-2012-0133819 filed in the Korean Intellectual Property Office on Nov. 23, 2012, the entire contents of which are incorporated herein by reference.

### BACKGROUND OF THE INVENTION

(a) Field of the Invention

The present invention relates to a method and a system for controlling a start of a hybrid electric vehicle, and more particularly to a method and a system which control a slip of a belt which connects an engine and an integrated starter-generator when the engine is being started.

(b) Description of the Related Art

Hybrid electric vehicles operate through the use of power from an internal combustion engine and power from a battery. In particular, hybrid electric vehicles are designed to efficiently combine and use power of the internal combustion engine and the motor.

For example, as illustrated in FIG. 1, a hybrid electric vehicle includes: an engine 10; a motor 20; an engine clutch 30 which controls power between the engine 10 and the motor 20; a transmission 40; a differential gear unit 50; a battery 60; an integrated starter-generator 70 which starts the engine 10 or generates electric power by output of the engine 10; and wheels 80.

As further shown, the hybrid electric vehicle includes: a hybrid control unit (HCU) 200 which controls overall operation of the hybrid electric vehicle; an engine control unit (ECU) which controls operation of the engine 10; a motor control unit (MCU) 120 which controls operation of the motor 20; a transmission control unit (TCU) 140 which controls operation of the transmission 40; and a battery control unit (BCU) 160 which manages and controls the battery 60.

The battery control unit 160 may also be referred to as a battery management system (BMS).

In the vehicle industry, the integrated starter-generator 70 may also be referred to as a starting/generating motor or a hybrid starter & generator.

The hybrid electric vehicle may run in a driving mode, such as an electric vehicle (EV) mode using only power of the motor 20, a hybrid electric vehicle (HEV) mode using torque of the engine 10 as main power and torque of the motor 20 as auxiliary power, and a regenerative braking (RB) mode during braking or when the vehicle runs by inertia. In the RB mode, braking and inertia energy are collected through power generation of the motor 20, and the battery 60 is charged with the collected energy.

The engine 10 is started by the integrated starter-generator 70 when the EV mode is changed into the HEV mode. The integrated starter-generator 70 also starts the engine 10 for the initial operation of the engine 10.

However, in the case that the engine 10 and the integrated starter-generator 70 are connected with a belt, a belt slip may occur while the engine 10 is being started.

The belt slip may occur when the torque of the integrated starter-generator 70 is forcedly changed without considering the characteristics of the belt.

As shown in FIG. 2, start and speed control are generally performed by a feedback control unit 300. The feedback control unit 300 includes a proportional unit 302, an integral unit 304, and a differential unit 306.

The feedback control unit 300 does not consider the torque change of the integrated starter-generator 70 while the start control is being performed. Therefore, in the case that the output of the feedback control unit 300 is too much for the purpose of a rapid engine start and speed control, the belt slip may occur, so that performance of the speed control and duration of the belt may be lowered.

It is known that the belt slip frequently occurs when the coolant temperature of the engine is low and the torque change of the integrated starter-generator is large.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provides a method and a system which prevent a slip of a belt which connects an engine and an integrated starter-generator while the engine is being started, by controlling the integrated starter-generator based on characteristics of the belt, a coolant temperature of the engine, and a torque change rate of the integrated starter-generator.

An exemplary embodiment of the present invention provides a method for controlling a start of a hybrid electric vehicle including a belt connecting an engine and an integrated starter-generator, the method including: measuring characteristic values of the belt and storing the measured characteristic values in a memory; measuring a slip torque change rate of the integrated starter-generator causing belt slip according to the measured characteristic values of the belt and storing the slip torque change rate in the memory; determining whether there is a start demand of the engine; sensing a coolant temperature of the engine when there is the start demand of the engine; matching the sensed coolant temperature to the slip torque change rate; and feedback controlling the integrated starter-generator so that the torque change rate of the integrated starter-generator may be limited within the slip torque change rate when the engine is started.

The characteristic values of the belt and the slip torque change rate are measured by a predetermined test method.

In the feedback controlling, PID (proportional integral differential) control may be performed.

Another exemplary embodiment of the present invention provides a system for controlling a start of a hybrid electric vehicle including a belt connecting an engine and an integrated starter-generator, the system including: a coolant temperature sensor configured to sense a coolant temperature of the engine; and a controller configured to prevent a belt slip on the belt based on a signal of the coolant temperature sensor, characteristic values of the belt, and a slip torque change rate of the integrated starter-generator while the engine is being started, wherein the controller is operated by a predetermined program, and the predetermined program includes a series of commands for performing the method of controlling the start of the hybrid electric vehicle.

The controller may include: a data storage unit configured to store the characteristic values of the belt and the slip torque change rate, wherein the characteristic values of the belt is pre-measured; a coolant temperature calculation unit configured to calculate a coolant temperature value based on the signal of the coolant temperature sensor; a slip torque change rate match unit configured to match the sensed coolant temperature to the slip torque change rate; a start demand determination unit configured to determine whether there is a start demand of the engine; a speed error calculation unit configured to calculate a difference between a control target speed and an actual speed of the integrated starter-generator; and a feedback control unit configured to control the integrated starter-generator so that the torque change rate of the integrated starter-generator may be limited within the slip torque change rate while the engine is being started.

The controller may further include: a PID (proportional integral differential) control unit configured to feedback-control the integrated starter-generator; and a torque change rate limit unit configured to limit the torque change rate of the integrated starter-generator within the slip torque change rate. The controller may furthermore include: an anti-wind-up gain unit configured to remove terms due to a difference between output of the PID control unit and output of the torque change rate limit unit from an integral control unit of the PID control unit.

As described above, according to the exemplary embodiment of the present invention, it is possible that prevent a slip of a belt which connects an engine and an integrated starter-generator while the engine is being started, by controlling the integrated starter-generator based on characteristic of the belt, a coolant temperature of the engine, and a torque change rate of the integrated starter-generator.

### BRIEF DESCRIPTION OF THE DRAWINGS

FIG. 1 is a block diagram illustrating a configuration of a typical hybrid electric vehicle.

FIG. 2 is a conventional schematic diagram illustrating a system for controlling a start of a hybrid electric vehicle according to the related art.

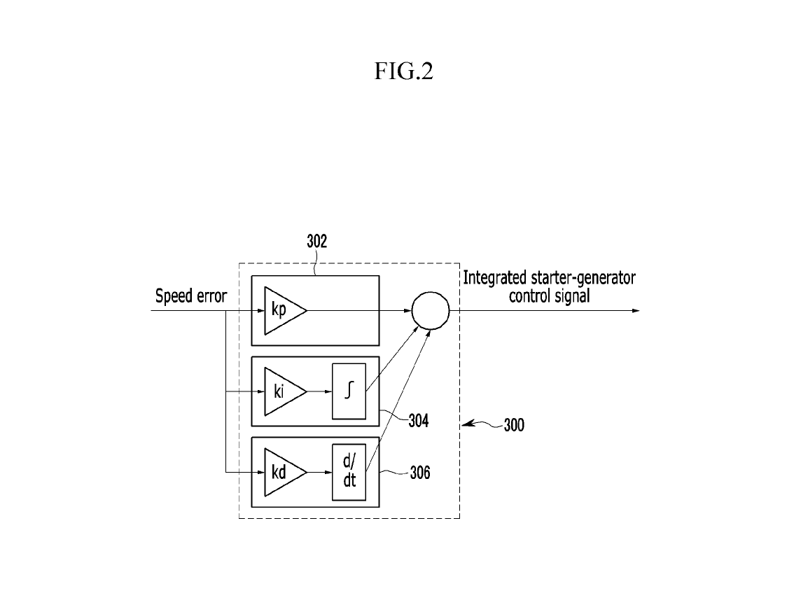

FIG. 3 is an exemplary configuration diagram of a system for controlling a start of a hybrid electric vehicle according to an exemplary embodiment of the present invention.

FIG. 4 is an exemplary detailed configuration diagram illustrating a feedback control unit in FIG. 3.

FIG. 5 is an exemplary flowchart of a method of controlling a start of a hybrid electric vehicle according to an exemplary embodiment of the present invention.

### DETAILED DESCRIPTION OF THE EMBODIMENTS

Hereinafter, an exemplary embodiment of the present invention will be described more fully with reference to the accompanying drawings. As those skilled in the art would realize, the described embodiments may be modified in various different ways, all without departing from the spirit or scope of the present invention.

Further, throughout the specification, like reference numerals refer to like elements.

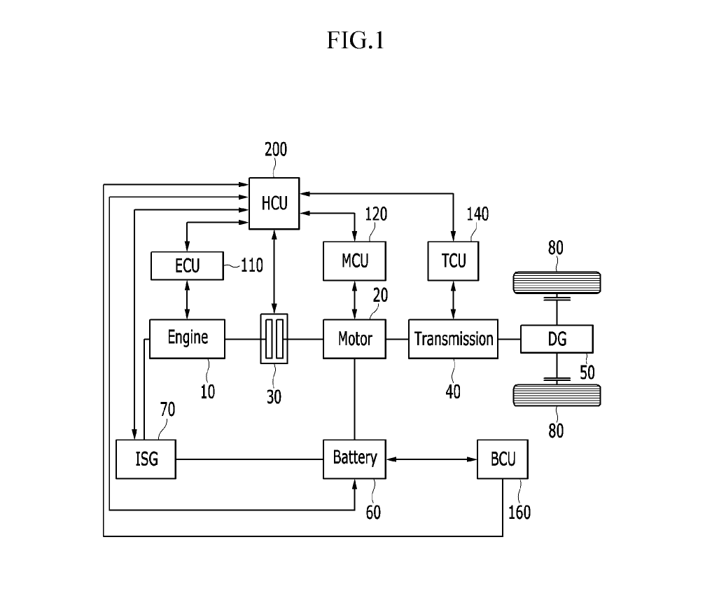

FIG. 1 is a diagram schematically illustrating a hybrid electric vehicle to which a system for controlling a start according to an exemplary embodiment of the present invention is applied.

As shown in FIG. 1, a hybrid electric vehicle to which a system for controlling a start according to an exemplary embodiment of the present invention is applied may include: an engine 10; a motor 20; an engine clutch 30 configured to control power between the engine 10 and the motor 20; a transmission 40; a differential gear unit 50; a battery 60; and an integrated starter-generator 70 configured to start the engine 10 or to generate electric power by output of the engine 10.

The hybrid electric vehicle may also include: a hybrid control unit (HCU) 200 configured to control overall operation of the hybrid electric vehicle; an engine control unit (ECU) 110 configured to control operation of the engine 10; a motor control unit (MCU) 120 configured to control operation of the motor 20; a transmission control unit (TCU) 140 configured to control operation of the transmission 40; and a battery control unit (BCU) 160 configured to manage and control the battery 60.

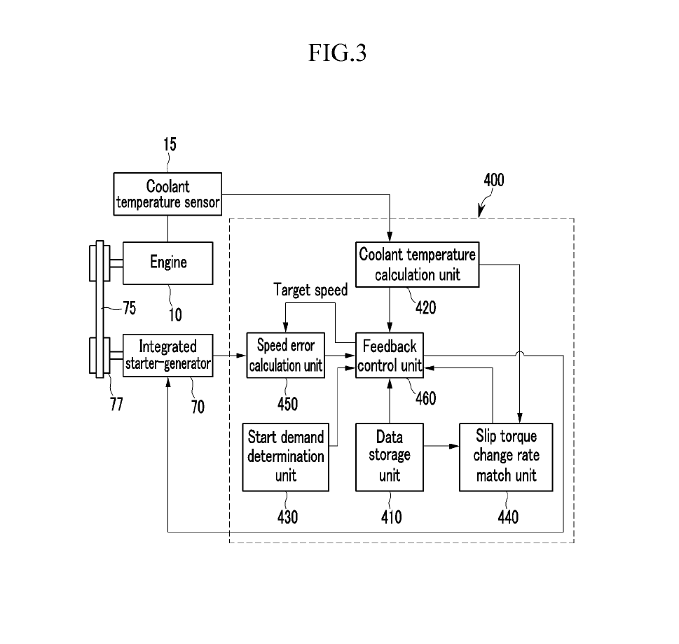

FIG. 3 is a configuration diagram of a system for controlling a start of a hybrid electric vehicle according to an exemplary embodiment of the present invention.

The system for controlling a start of a hybrid electric vehicle according to an exemplary embodiment of the present invention is a system that may control the engine 10 through controlling the integrated starter-generator 70.

The system includes: the engine 10 and the integrated starter-generator 70 connected by a belt 75; a coolant temperature sensor 15 sensing a coolant temperature of the engine 10; and a controller 400 preventing occurrence of a slip of the belt 75 based on a signal of the coolant temperature sensor 15, pre-measured characteristic values of the belt 75 and/or a pulley 77, and a slip torque change rate of the integrated starter-generator 70, when the engine is started.

In the exemplary embodiment of the present invention, the coolant temperature sensor 15 is in the form of a sensor which is mounted on a coolant water path of an intake manifold, and senses the coolant temperature of the engine 10. However, the coolant temperature sensor 15 may vary, and thus is not limited to this example. Other configurations capable of substantially sensing the coolant temperature of the engine 10 may be used in the exemplary embodiment of the present invention.

The engine 10 and the integrated starter-generator 70 may correspond to those that are used in a general hybrid electric vehicle.

As the exemplary embodiment of the present invention relates to the start of the engine, the integrated starter-generator 70 may be regarded as a starting motor.

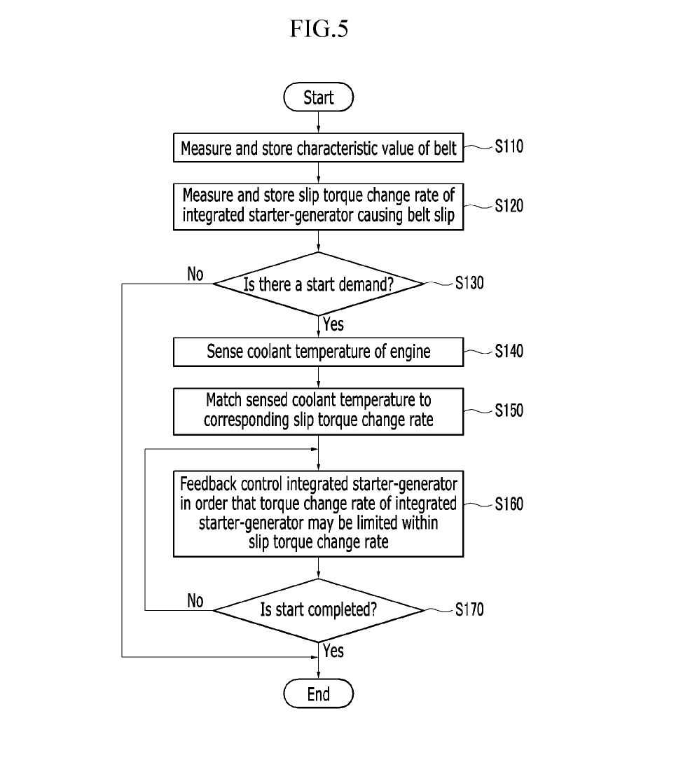

The controller 400 may include one or more processors or microprocessors and/or hardware operated by a program including a series of commands for executing processes of the flowchart illustrated in FIG. 5.

In the exemplary embodiment of the present invention, the controller 400 may include: the engine control unit (ECU) 110 configured to control the operation of the engine 10 of the hybrid electric vehicle; and the hybrid control unit (HCU) 200 configured to control the overall operation of the hybrid electric vehicle including the operation of the integrated starter-generator 70.

In the method of controlling the start of the hybrid electric vehicle according to an exemplary embodiment of the present invention to be described below, partial processes may be executed by the ECU and remaining processes may be executed by the HCU.

The scope of the present invention is not limited to a following exemplary embodiment. The controller may be implemented by being incorporated with the description of an exemplary embodiment of the present invention. Further, the ECU and the HCU may perform different combinations of processes than those described in the exemplary embodiment.

The controller 400 may include detailed constituent elements as shown in FIG. 3. The detailed constituent elements shown in FIG. 3 may be configured with one or more modules with hardware and software.

Referring to FIG. 3, the controller 400 may include a data storage unit 410 configured to store the characteristic values of the belt 75 and/or pulley 77 that are pre-measured by a predetermined test method known to a person of ordinary skill in the art, and the slip torque change rate.

The slip torque change rate is data which is measured by a predetermined measuring method. The slip torque change rate is the torque change rate with the integrated starter-generator 70 that generates the belt slip while starting the engine 10.

The data storage unit 410 may include a memory.

The controller 400 may include: a coolant temperature calculation unit 420 configured to calculate a coolant temperature value based on the signal of the coolant temperature sensor 15; a slip torque change rate match unit 440 configured to match the sensed coolant temperature to the slip torque change rate; a start demand determination unit 430 configured to determine whether there is a start demand of the engine 10; a speed error calculation unit 450 configured to calculate a difference between a control target speed and an actual speed of the integrated starter-generator 70; and a feedback control unit 460 configured to control the integrated starter-generator 70 so that the torque change rate of the integrated starter-generator may be limited within the slip torque change rate, while the engine 10 is being started.

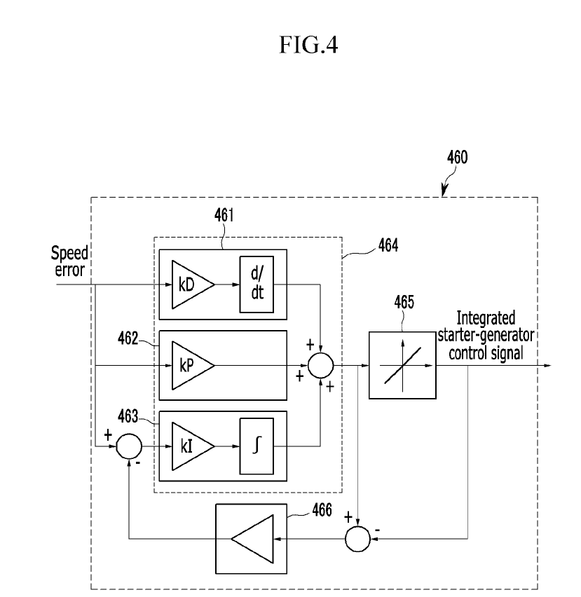

The feedback control unit 460, as shown in FIG. 4, may include detailed constituent elements.

Referring to FIG. 4, the feedback control unit 460 may include: a proportional integral differential (PID) control unit 464 configured to feedback-control the integrated starter-generator 70; a torque change rate limit unit 465 configured to limit the torque change rate of the integrated starter-generator 70 to the slip torque change rate; and an anti-wind-up gain unit 466 configured to remove terms (or values) due to a difference between output of the PID control unit 464 and output of the torque change rate limit unit 465 from an integral control unit of the PID control unit 464.

The torque change rate limit unit 465 may consider speed of the engine 10 which is being started, to limit the torque change rate of the integrated starter-generator 70.

That is, the torque change rate limit unit 465 may limit the torque change rate of the integrated starter-generator 70 based on the coolant temperature of the engine 10, the characteristic values of the belt 75, and the speed of the engine 10 which is being started.

The PID control unit 464 may include a differential control unit 461, a proportional control unit 462, and an integral control unit 463.

Hereinafter, a method of controlling a start of a hybrid electric vehicle according to an exemplary embodiment of the present invention is described in detail with reference to the accompanying drawings.

FIG. 5 is an exemplary flowchart illustrating a method of controlling a start of an engine according to an exemplary embodiment of the present invention.

Referring to FIG. 5, the characteristic values of the belt 75 that are pre-measured through the predetermined test method are previously stored to the data storage unit 410 of the controller 400. The characteristic values of the belt 75 include frictional force associated with the belt slip and so on.

Also, the slip torque change rate of the integrated starter-generator 70 to cause the belt slip is measured through the predetermined test method, and is stored to the data storage unit 410 of the controller 400, per corresponding coolant temperatures of the engine 10 while starting the engine 10 (S120).

When the slip torque change rate is measured, the characteristic values of the belt 75 may be considered.

As described above, in the state that the characteristic values of the belt 75 and the slip torque change rate are stored in the data storage unit 410, the controller 400 determines whether there is a start demand through the start demand determination unit 430 (S130).

The start demand may refer to when the engine 10 is initially started up for using or running the hybrid electric vehicle or when an EV mode is changed to an HEV mode.

When it is determined that there is a start demand in step S130, the controller 400, through the coolant temperature calculation unit 420, calculates the coolant temperature of the engine 10 based on the signal of the coolant temperature sensor 15 (S140).

When the coolant temperature of the engine 10 is calculated in step S140, the controller 400 searches the slip torque change rate corresponding to the calculated coolant temperature in the data storage unit 410, and then matches them (S150).

When the calculated coolant temperature and the slip torque change rate corresponding to the calculated coolant temperature are matched, the controller 400, through the feedback control unit 460, applies a target torque signal to the integrated starter-generator 70 and operates the integrated starter-generator 70.

When the integrated starter-generator 70 is operated by the target torque signal, the engine 10 connected with the belt 75 begins to be started.

When the engine 10 begins to be started, the speed error calculation unit 450 of the controller 400 calculates a difference (or an error) between the target speed of the integrated starter-generator 70 corresponding to the target torque and the actual speed of the integrated starter-generator 70.

When the difference between the target speed and the actual speed of the integrated starter-generator 70 is calculated, the feedback control unit 450 of the controller 400 calculates the torque change rate of the integrated starter-generator 70 based on the difference between the target speed and the actual speed.

When the torque change rate of the integrated starter-generator 70 is calculated, the feedback control unit 460 determines whether the torque change rate is below the slip torque change rate, and feedback controls the operation of the integrated starter-generator 70 so that the torque change rate of the integrated starter-generator 70 may be limited within the slip torque change rate (S160).

In step S160, if the start of the engine 10 is competed while the integrated starter-generator 70 is feedback controlled (S170), the feedback control unit 460 terminates the feedback control on the integrated starter-generator 70.

When the feedback control unit 460 performs step S160, the feedback control unit 460, through the PID control unit 464 shown in FIG. 4, feedback controls the integrated starter-generator 70.

Further, in step S160, the feedback control unit 460, through the torque change rate limit unit 465, controls the integrated starter-generator 70 so that the torque change rate of the integrated starter-generator 70 may not exceed the slip torque change rate.

When the feedback control unit 460, through the PID control unit 464 and the torque change rate limit unit 465, performs step S160, signal terms (or signal values) due to differences between output signals of the PID control unit 464 and output signals of the torque change rate limit unit 465 are accumulated in the integral control unit 463, which may reduce control performance on the integrated starter-generator 70.

Accordingly, the feedback control unit 460, through the anti-wind-up gain unit 466, removes the accumulated signal terms (or signal values) due to differences between output signals of the PID control unit 464 and output signals of the torque change rate limit unit 465 from the integral control unit 463.

Hence, according to the exemplary embodiment of the present invention, it is possible to start an engine without a belt slip by controlling an integrated starter-generator to below a torque change rate causing the belt slip.

While this invention has been described in connection with what is presently considered to be exemplary embodiments, it is to be understood that the invention is not limited to the disclosed embodiments, but, on the contrary, is intended to cover various modifications and equivalent arrangements included within the spirit and scope of the accompanying claims.

### DESCRIPTION OF REFERENCE NUMERALS

10: engine 15: coolant temperature sensor 70: integrated starter-generator 400: controller 410: data storage unit 420: coolant temperature calculation unit 430: start demand determination unit 440: slip torque change rate match unit 450: speed error calculation unit 460: feedback control unit

What is claimed is:

1. A method for controlling a start of a hybrid electric vehicle having a belt connecting an engine and an integrated starter-generator, the method comprising:
measuring characteristic values of the belt and storing the measured characteristic values in a memory;
measuring a slip torque change rate of the integrated starter-generator causing belt slip according to the measured characteristic values of the belt and storing the slip torque change rate in the memory;
determining whether a start of the engine is requested;
sensing a coolant temperature of the engine when the start of the engine is requested;
matching the sensed coolant temperature to the slip torque change rate; and
feedback controlling the integrated starter-generator so that the torque change rate of the integrated starter-generator may be limited within the slip torque change rate when starting the engine.

2. The method of claim 1, wherein the characteristic values of the belt and the slip torque change rate are measured by a predetermined test method.

3. The method of claim 1, wherein, in the feedback controlling, PID (proportional integral differential) control is performed.

4. A system for controlling a start of a hybrid electric vehicle including a belt connecting an engine and an integrated starter-generator, the system comprising:
a coolant temperature sensor configured to sense a coolant temperature of the engine; and
a controller configured to prevent a belt slip on the belt based on a signal of the coolant temperature sensor, characteristic values of the belt, and a slip torque change rate of the integrated starter-generator, while the engine is being started,
wherein the controller is operated by a predetermined program, the predetermined program including a series of commands for performing the method, comprising:
measuring characteristic values of the belt and storing the measured characteristic values in a memory; measuring a slip torque change rate of the integrated starter-generator causing belt slip according to the measured characteristic values of the belt and storing the slip torque change rate in the memory; determining whether a start of the engine is requested; sensing a coolant temperature of the engine when the start of the engine is requested; matching the sensed coolant temperature to the slip torque change rate; and feedback controlling the integrated starter-generator so that the torque change rate of the integrated starter-generator may be limited within the slip torque change rate when starting the engine.

5. The system of claim 4, wherein the controller comprises:
a data storage unit configured to store the characteristic values of the belt and the slip torque change rate, wherein the characteristic values of the belt are pre-measured;
a coolant temperature calculation unit configured to calculate a coolant temperature value based on the signal of the coolant temperature sensor;
a slip torque change rate match unit configured to match the sensed coolant temperature to the slip torque change rate;
a start demand determination unit configured to determine whether there is a start demand of the engine;
a speed error calculation unit configured to calculate a difference between a control target speed and an actual speed of the integrated starter-generator; and
a feedback control unit configured to control the integrated starter-generator so that the torque change rate of the integrated starter-generator may be limited within the slip torque change rate while the engine is being started.

6. The system of claim 5, wherein
the controller further comprises:
a PID (proportional integral differential) control unit configured to feedback-control the integrated starter-generator; and
a torque change rate limit unit configured to limit the torque change rate of the integrated starter-generator within the slip torque change rate.

7. The system of claim 6, wherein
the controller further comprises
an anti-wind-up gain unit configured to remove terms due to a difference between output of the PID control unit and output of the torque change rate limit unit from an integral control unit of the PID control unit.
